(19) United States
(12) Patent Application Publication
(10) Pub. No.: US 2002/0077904 A1
(43) Pub. Date: Jun. 20, 2002

(54) Loyalty program

(76) Inventor: Naushad Ali, Monroe, WA (US)

Correspondence Address: PERKINS COIE LLP, PATENT-SEA, P.O. BOX 1247, SEATTLE, WA, 98111-1247, US

(21) Appl. No.: 09/911,853

(22) Filed: Jul. 23, 2001

Related U.S. Application Data
(60) Provisional application No. 60/255,993, filed on Dec. 14, 2000.

(51) Int. Cl. G06F 17/60

(52) U.S. Cl. 705/14; 705/35; 705/36

(57) ABSTRACT

A facility for operating a loyalty program is described. The facility monitors purchases made by each of a plurality of customers from merchants that are among a limited set of merchants. The facility then conveys to customers among the plurality—selected based upon their monitored purchases—a financial instrument having a face value, whose acquisition cost is less than that face value.

### CROSS REFERENCE TO RELATED APPLICATION

This application claims the benefit of U.S. Provisional Application No. 60/255,993 filed on Dec. 14, 2000, which is hereby incorporated by reference in its entirety.

### TECHNICAL FIELD

The present invention is directed to the field of sales promotions, and, more particularly, to the field of customer loyalty programs.

### BACKGROUND

The field of marketing is concerned with developing and applying strategies for (1) inducing new potential customers to purchase products or services from a particular purveyor, and (2) inducing existing customers of the purveyor to purchase from it more regularly, more frequently, and/or in greater quantity. (These purveyors of products and services are hereafter referred to as “merchants.”) When a merchant is able to successfully apply such strategies, it is often able to realize substantial ongoing gains in revenue and profits.

This is true for online merchants that sell products and services via the World Wide Web (“the web”) and brick and mortar merchants that sell products and services from stores, kiosks, and other physical locations. Both types of merchants need to help customers choose them, both from the space in which they exist, and from the list of merchants in their market segment. Both types of merchants also need to keep customers coming back. Additionally, many merchants, especially brick and mortar merchants, would benefit from obtaining more information about their customers relating to their interest in buying certain products and services, and their capacity to do so.

Some conventional marketing approaches to obtaining and keeping customers exist, each of which has significant disadvantages. One such conventional marketing approach is to offer “cash back”: at the end of a year of shopping, a customer receives a certain percentage of the total amount of qualifying purchases made over that year. For instance, a customer may receive 1% of the total amount charged to a particular credit card during that year, or 2% of the total amount spent at a certain sporting goods store. Because this rebate is in cash, it is regarded by many customers as a deferred discount. Because almost any merchant can and does periodically give discounts, offering such a rebate does not tend to differentiate the offering merchant from competitors to a significant degree. Also, because the rebate may be paid up to 14 months after a particular purchase is made, the rebate may be viewed disfavorably by customers relative to a discount of the same amount, which is effective immediately at the time of purchase. Further, because the value of the rebate perceived by the customer is no greater than the cost of the rebate to the merchant, the cost of the rebate to the merchant may reach substantial, and even prohibitive levels before the perceived value of the rebate becomes significant to the customer.

Another conventional marketing approach is to offer reward points in exchange for qualifying purchases. At some point, these points may be exchanged for a prize, such as one of a relatively small number of prize items, or a gift certificate to one of a relatively small number of merchants. For example, a customer may be able to exchange 200 points for a pair of sunglasses, or 2500 points for a beach umbrella. The appeal of such programs is typically limited to the subset of customers that wish to receive one of the available prizes. Also, customers may be discouraged from making a significant effort to accumulate points by the difficulty of ascertaining the ultimate value of a point.

Another conventional marketing approach is to offer airline miles in exchange for purchases, such as purchases of airline tickets. When a sufficient number of such miles are accumulated, they may be exchanged for bonuses such as free airline tickets, or seat upgrades for paid airline tickets. The motivational potential of such programs is typically limited by their specific terms. For example, the number of miles required to obtain a bonus is often set so high as to prevent all customers except a very small percentage who must fly frequently for business purposes from ever obtaining a bonus, even if a customer buys airline tickets exclusively from the merchant. Also, the supply of bonuses is often heavily restricted, preventing even a customer that has successfully amassed the required number of miles from obtaining a bonus.

In view of the significance of the aforementioned shortcomings of conventional marketing programs, a customer loyalty program that overcame such shortcomings would have substantial utility to its customer members, its operator, and the affiliated merchants.

### BRIEF DESCRIPTION OF DRAWINGS

FIG. 1 is a display diagram showing a registration form typically completed by a customer in order to become a member of the loyalty program conducted using the facility.

FIG. 2 is a display diagram showing a display typically presented by the facility that shows an initial reward program transaction history.

FIG. 3 is a display diagram showing a display typically presented by the facility that lists all of the affiliated merchants in a single list.

FIG. 4 is a display diagram showing a display typically presented by the facility that lists a number of product and service categories.

FIG. 5 is a display diagram showing a list of affiliated merchants in the books category.

FIG. 6 is a display diagram showing a page of an affiliated merchant's web site containing information about a product that the member wishes to purchase.

FIG. 7 is a display diagram showing a page of an affiliated merchant's site that shows the desired product in the member's cart contents.

FIG. 8 is a display diagram showing a page of an affiliated merchant's site on which the member identifies him- or herself.

FIG. 9 is a display diagram showing an account management page of the loyalty program web site.

FIG. 10 is a display diagram showing a page of the loyalty program web site containing transaction history information for the member.

FIG. 11 is a data flow diagram showing a typical flow of transaction information from merchants to the operator of the loyalty program in accordance with the facility.

FIG. 12 is a data flow diagram showing additional detail regarding the processing of information about transactions conducted at a brick and mortar merchant, at the “point of sale.”

FIG. 13 is a data flow diagram showing additional detail regarding the processing of information within the control of the operator of the loyalty program.

FIG. 14 is a block diagram showing some of the components typically incorporated in at least some of the computer systems and other devices on which the facility executes.

FIG. 15 is a flow diagram showing steps typically performed by the facility in order to conduct the loyalty program.

### DETAILED DESCRIPTION

A software facility for conducting a customer loyalty program (“the facility”) is provided. The customer loyalty program assists merchants affiliated with the program (“affiliated merchants”) in attracting new customers, maintaining existing customers, and encouraging increased levels of spending from existing customers. The program also enables its customer members to obtain value in exchange for directing their spending to particular merchants, as well as facilitating saving by its members. The program further enables its operator to generate a profit.

In certain embodiments, the facility enables customer members of the loyalty program to obtain and accumulate a reward currency, which in some embodiments is called “BondDollars.” A member may obtain BondDollars by making a purchase from a merchant affiliated with the program. In particular, each affiliated merchant may set a reward percentage, such that, when a member purchases any item from the merchant, the member receives an amount of the BondDollars currency equal to the purchase price of the item multiplied by the merchant's reward percentage. For example, an affiliated merchant that sells books may set a reward percentage of 5%, thereby offering members 5% of the amounts of their book purchases in BondDollars. In this case, when a member purchases a $40 book, the member receives 2 BondDollars.

In many embodiments, members may exchange BondDollars for a reward financial instrument that has a known future value that exceeds its acquisition cost, such as certain savings bonds and certificates of deposit. Research suggests that, as rewards, customers value such financial instruments based upon their future value, even when they understand that their acquisition cost is lower. That is, customers may value a 2 BondDollars credit the same as a $2 cash discount. Indeed, in some research cases, customers have valued a BondDollars credit of a particular amount more highly than a cash discount of the same amount, in view of the extent to which the BondDollars credit facilitates the saving process. This difference between perceived value and acquisition cost enables the loyalty program and its affiliated merchants to provide a loyalty reward having a higher value to customer members than the cost to provide it, enabling the program to provide higher-value rewards at a lower cost, benefiting both members and affiliated merchants. The difference between perceived value and acquisition cost also enables the operator of the program to extract a profit from the sale of BondDollars.

As an extension of the example above, the 2 BondDollars obtained by the member for purchasing a $40 book may be worth $2 or more to the member. The 2 BondDollars are purchased by the affiliated merchant from the loyalty program for $1.20, thereby getting $2 or more of customer motivation value for 60% of that amount. The operator of the program, at some future time, will spend $1 of that $1.20 purchasing a savings bond for the customer, thereby retaining 10 cents for each credited BondDollar to cover the cost of operating the program and obtain a profit.

When a member's BondDollar balance reaches a known future value of a reward financial instrument, the member receives the reward financial instrument. For example, in one embodiment, a member receives a Series EE U.S. savings bond with a face value of $50 when the member accumulates 50 BondDollars. In this case, the member may choose to receive the savings bond him- or herself, or may designate a donee, such as a grandchild, to whom to give the savings bond as a gift. In some embodiments, the savings bond is sent directly to the designated recipient by the U.S. Department of the Treasury, minimizing the cost to the operator of the program of providing the savings bond. Once the savings bond is received, it may be retained, given as a gift, or redeemed for cash. On the savings bond's maturity date, it can be redeemed for its face value.

In order to open an account in which to accumulate BondDollars, a customer registers as a member of the program, typically on a program web site. As part of the registration process, the customer provides identifying and/or demographic information, some or all of which may be provided to affiliated merchants to support their marketing efforts and better know their customers, and/or used directly by the program to selectively market to the customer on behalf of the affiliated merchants. In some embodiments, a new member receives a small quantity of BondDollars in return for registering and/or providing personal information.

After registering, members may return to the program web site at any time to check their BondDollars balances and review transactions with affiliated merchants that have been credited to their BondDollars accounts. Members may also use the program web site to identify affiliated merchants that sell particular types of products or services, and review their reward percentages.

The facility provides significant advantages to affiliated merchants. These include: obtaining customers from other affiliated merchants; providing customers with a meaningful prize earlier than if the merchant was operating its own loyalty program; sharing advertising expenses with other affiliated merchants; offering a loyalty reward whose perceived value significantly exceeds its cost; helping their customers to save; and obtain useful information about your customers that is difficult to otherwise obtain.

The facility provides significant advantages to customer members, including: providing a tangible reward that promotes saving, has tax advantages, and can be cashed in, sold, or given away, without having to dilute that reward by dividing spending between many different loyalty programs.

The facility provides significant advantages to its operator, including: reward fulfillment whose cost is subsidized, and profit made possible by the elevated perceived value of the reward instrument.

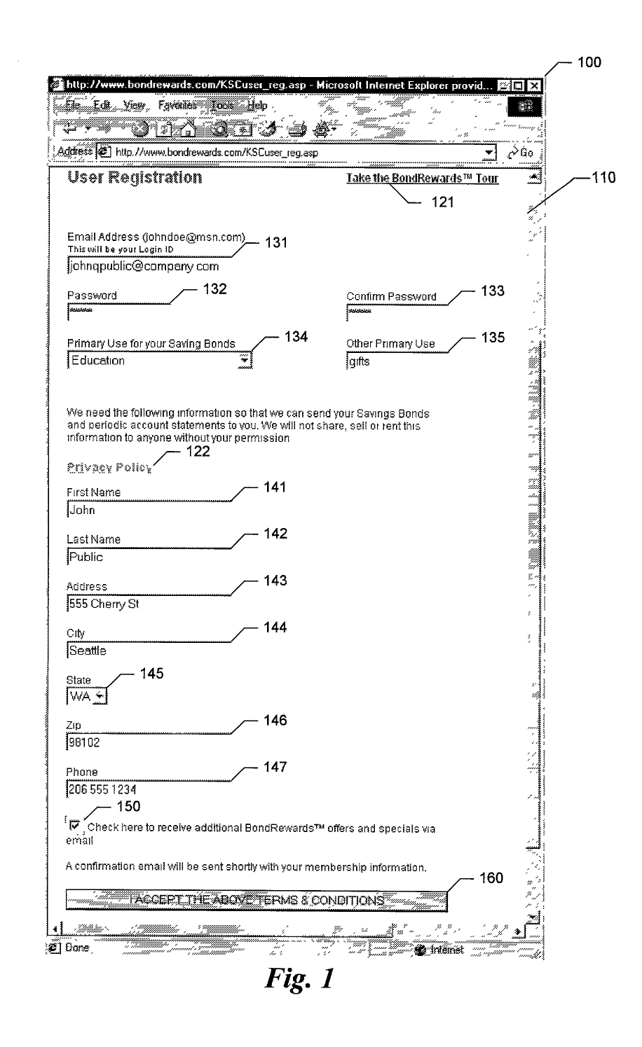

In order to more fully describe the facility, an example of its use to conduct a customer loyalty program for a particular customer is discussed below in conjunction with FIGS. 1-10.

FIG. 1 is a display diagram showing a registration form typically completed by a customer in order to become a member of the loyalty program conducted using the facility. The registration form shown here is a web page 110 displayed in the client area of a web browser application window 100. The form includes links, including link 121 for displaying an overview of the loyalty program, and link 122 for displaying a privacy policy setting forth how the loyalty program uses personal information provided by its members. The form also includes fields for entering high-level membership information, including field 131 for entering an email address to be used by the customer as a member identifier; fields 132 and 133 for entering a password used to authenticate the user to the loyalty program; and fields 134 and 135 for entering uses to which the customer expects put savings bonds obtained through the program. The form also includes fields for entering additional contact information for the customer, including: fields 141 and 142 for entering the customer's first and last name; fields 143-146 for entering the customer's street address; and field 147 for entering the customer's phone number. The form further contains a checkbox 150 that may be checked in order to receive email addresses about additional offers and specials in connection with the loyalty program. The form further contains a button 160 that the customer may click in order to complete the registration process. In some embodiments, the customer receives a quantity of BondDollars in return for registering as a member, or in return for completing a further customer questionnaire (not shown).

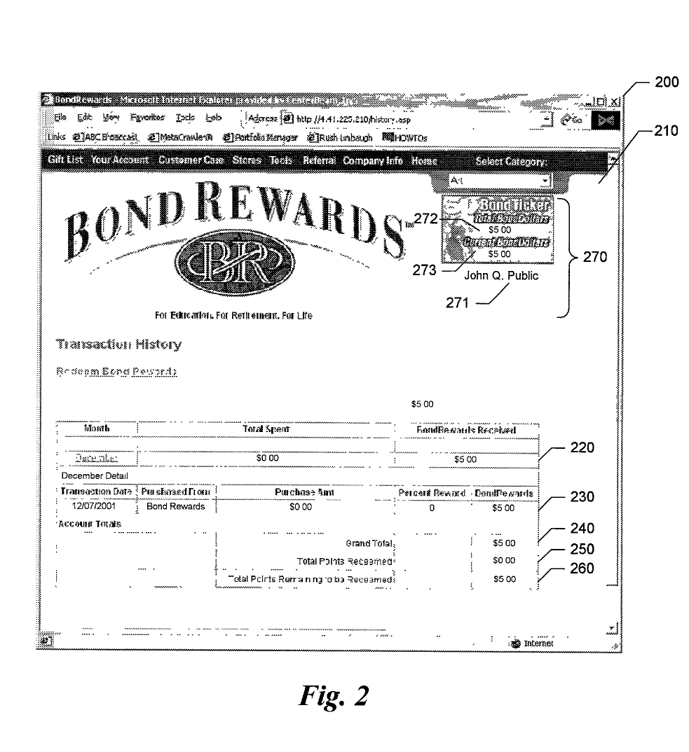

FIG. 2 is a display diagram showing a display typically presented by the facility that shows an initial reward program transaction history. The display 210, line 220 indicates that 5 BondDollars were received in the month of December. In row 230, it can be seen that those 5 BondDollars were received from the operator of the loyalty program on Dec. 7, 2001 in response to registering and/or completing a questionnaire. Line 240 indicates that a total of 5 BondDollars have been earned by this member. Line 250 indicates that none of these BondDollars has been redeemed. Accordingly, line 260 indicates that 5 BondDollars remain to be redeemed. Display 210 also includes a compact balance display 270 that shows the name 271 of the member, the total number of BondDollars earned 272, and the number of BondDollars remaining to be redeemed 273.

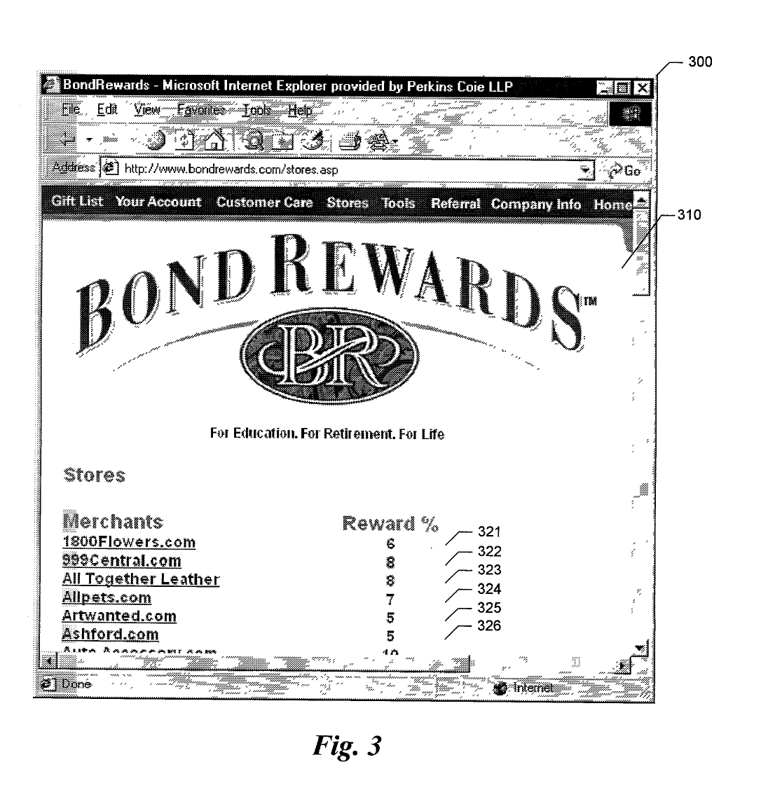

FIGS. 3-5 show typical user interfaces provided by the facility to identify merchants affiliated with the loyalty program. FIG. 3 is a display diagram showing a display typically presented by the facility that lists all of the affiliated merchants in a single list. It can be seen that this display 310 contains the names of a number of merchants, such as merchants 321-326. In each case, the name is a link that the member can select in order to go to that merchant's web site, and is accompanied by an indication of the reward percentage offered by that merchant. For example, it can be seen on line 321 that the merchant 1800Flowers.com offers a reward percentage of six percent.

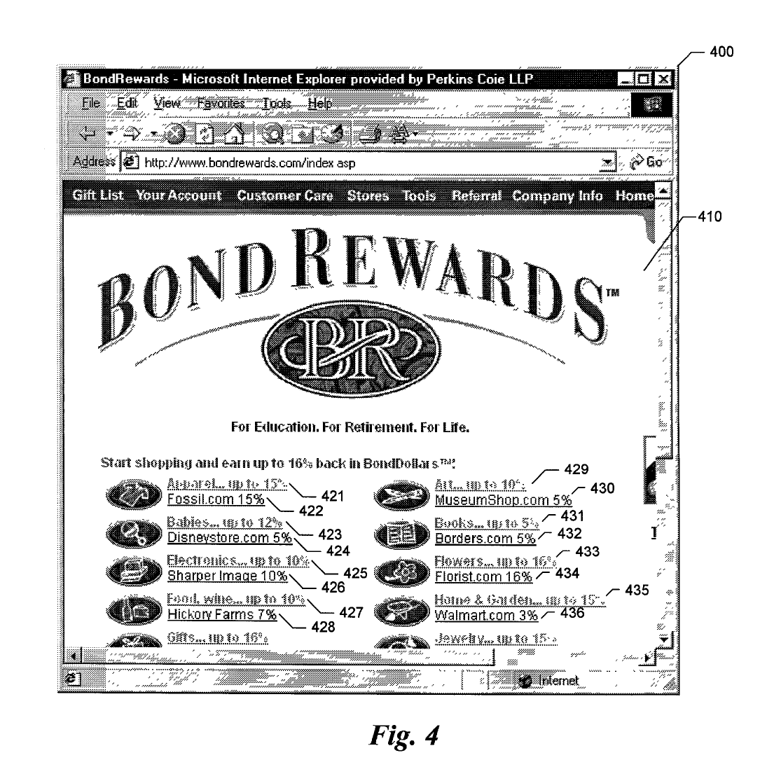

In addition to, or instead of, an exhaustive list of all merchants, the facility may display lists of merchants by product or service category. FIG. 4 is a display diagram showing a display typically presented by the facility that lists a number of product and service categories. It can be seen that display 410 contains a number of such categories, including an apparel category 421, a babies category 423, an electronics category 425, and a food and wine category 427. These categories are accompanied by images which further helps to identify the categories. Each of the category names is a link that the member can select in order to view a list of the affiliated merchants in that category. Also included is a highest reward percentage among the affiliated merchants in a particular category. Further included with each category is the name of a featured merchant in that category, such as featured merchants 422, 424, 426, and 428. The names of featured merchants are links that the member may select in order to visit these merchants.

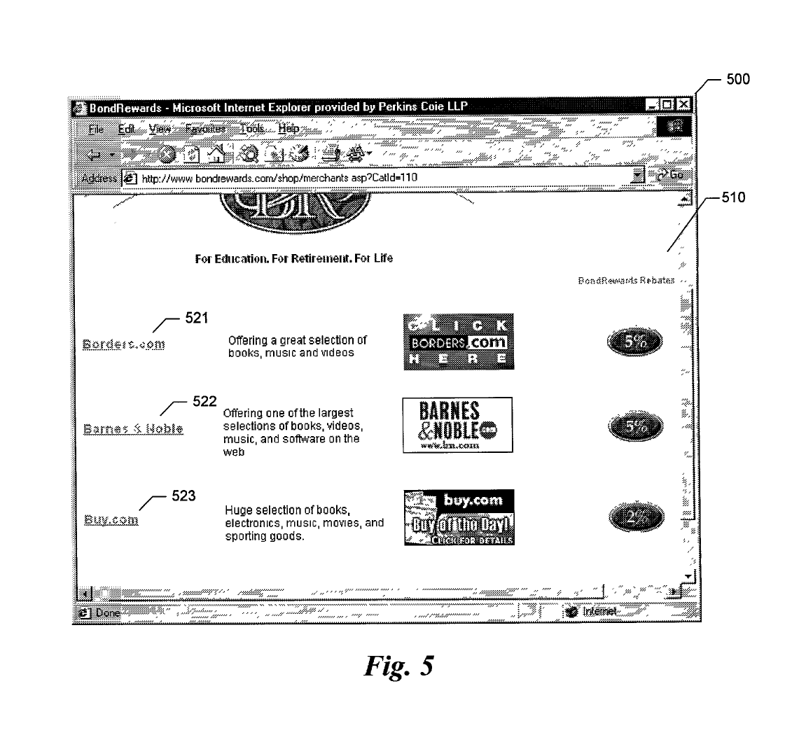

FIG. 5 is a display diagram showing a list of affiliated merchants in the books category. Such a display may typically be reached by selecting link 431 for the books category shown in FIG. 4. The display 510 includes three affiliated merchants in the books category, merchants 521, 522, and 523. The name of each merchant is a link that the member can select in order to go to that merchant's web site. A brief description of each of these merchants, an advertising banner for the merchant, and the reward percentage offered by the merchant accompanies the merchant's name.

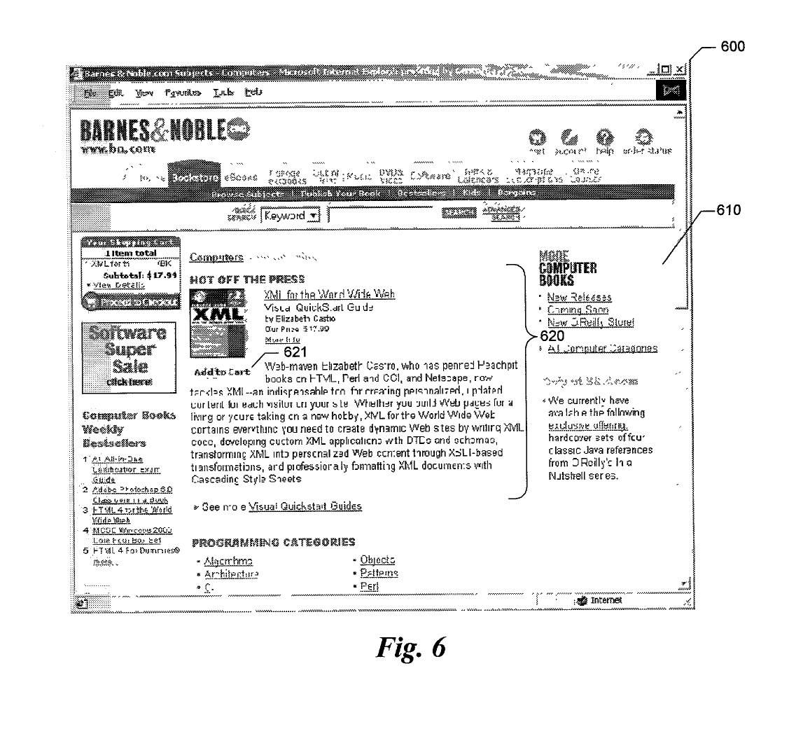

FIGS. 6-8 show the member interacting with the web site of an affiliated merchant in order to purchase a product. The member may reach the affiliated merchant's web site by following a link from the loyalty program web site, such as link 522, or by any other means, such as typing the URL of the merchant's web site into the URL field of a web browser; selecting a shortcut to the affiliated merchant's web site; clicking on a banner advertisement for the affiliated merchant displayed on a third-party web site; or selecting any other link to the affiliated merchant's web site.

FIG. 6 is a display diagram showing a page of an affiliated merchant's web site containing information about a product that the member wishes to purchase. The page 610 includes a section 620 containing information about the desired product. This information includes a button 621 for adding the desired product to the member's shopping cart at the merchant. Where the merchant's web site includes other kinds of controls for purchasing a product, these may instead be used by the member to purchase products.

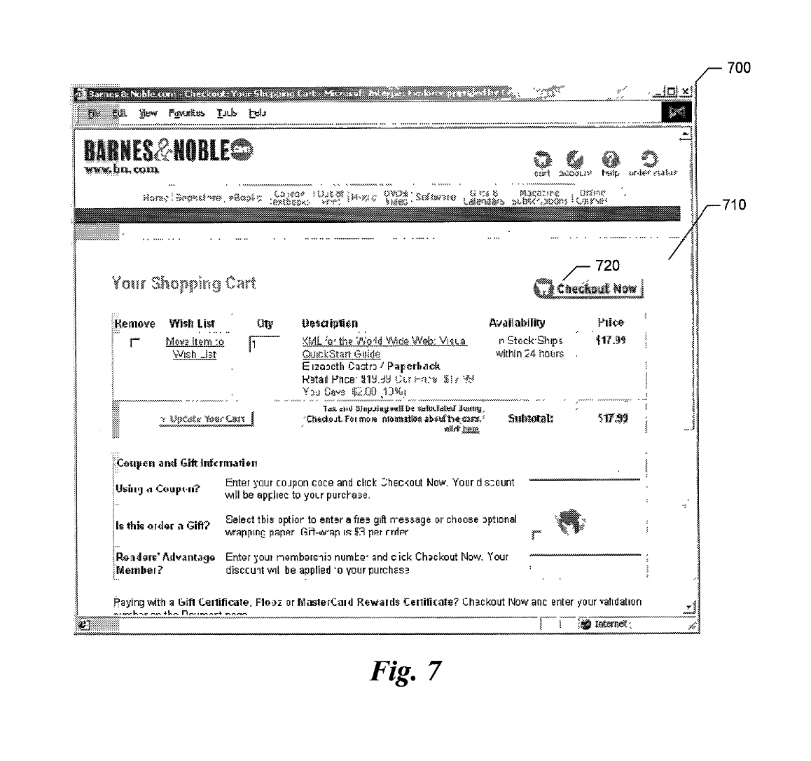

In response to selecting button 621, a shopping cart page from the merchant's web site is displayed. FIG. 7 is a display diagram showing a page of the affiliated merchant's site that shows the desired product in the member's cart contents. The page 710 includes information identifying the product added to the shopping basket, as well as a button 720 that may be selected in order to check out and purchase the desired item.

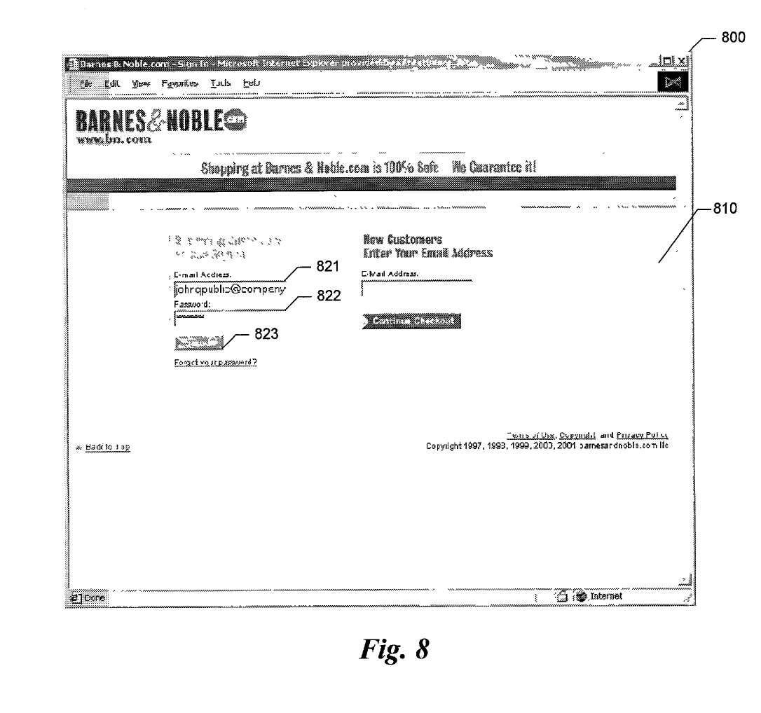

When the member selects button 720, a page of the merchant's web site is displayed where the member identifies him- or herself to the merchant's web site. FIG. 8 is a display diagram showing a page of the affiliated merchant's site on which the member identifies him- or herself. The page 810 contains a field 821 for entering the member's email address, a field 822 for entering the member's password for this merchant, and a button 823 that can be selected in order to sign in to the merchant's web site. After the member does so, the member provides payment and shipment information, and gives final approval for the purchase.

Members may also earn BondDollars by making purchases from brick and mortar merchants at their physical stores. In this case, the member identifies him- or herself as a particular loyalty program member when paying for the purchase. This can be achieved in a variety of manners, including: presenting a specialized loyalty program identification card; presenting an identification card, debit card, or credit card issued by the merchant; paying with a uniquely identified form of payment, such as third-party issued credit card or debit card, or a personal check; or giving the merchant the member's home phone number. As is discussed further below, information about these purchases is transmitted to the operator of the loyalty program in a manner similar to information about purchases made from online merchants.

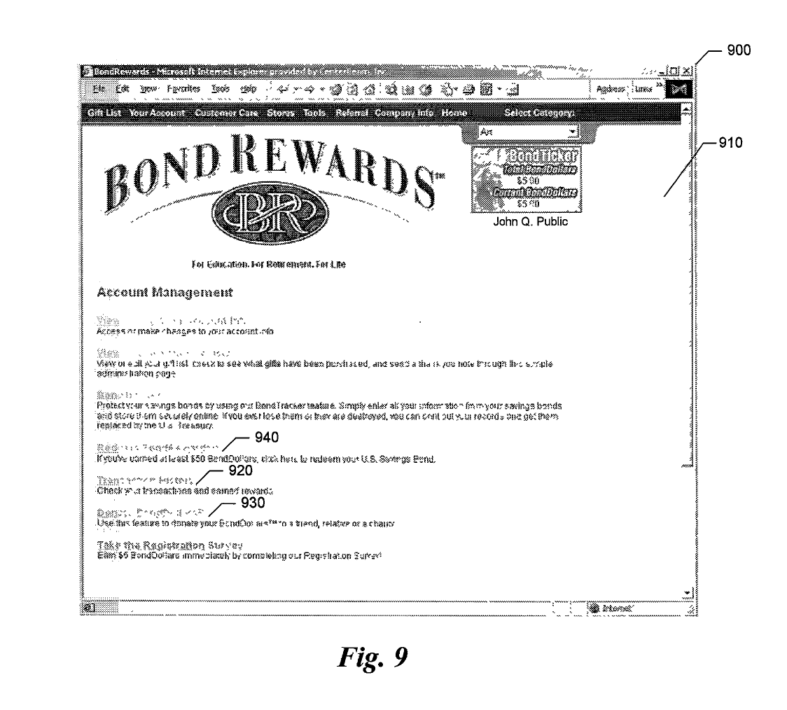

After purchasing a product or service, the member may return to the web site of the loyalty program. FIG. 9 is a display diagram showing an account management page of the loyalty program web site. The page 910 includes links, among others, for reviewing the member's transaction history 920, donating BondDollars to another person or a charity 930, and redeeming BondDollars for savings bonds 940. The member may select one of these links in order to display the corresponding web page.

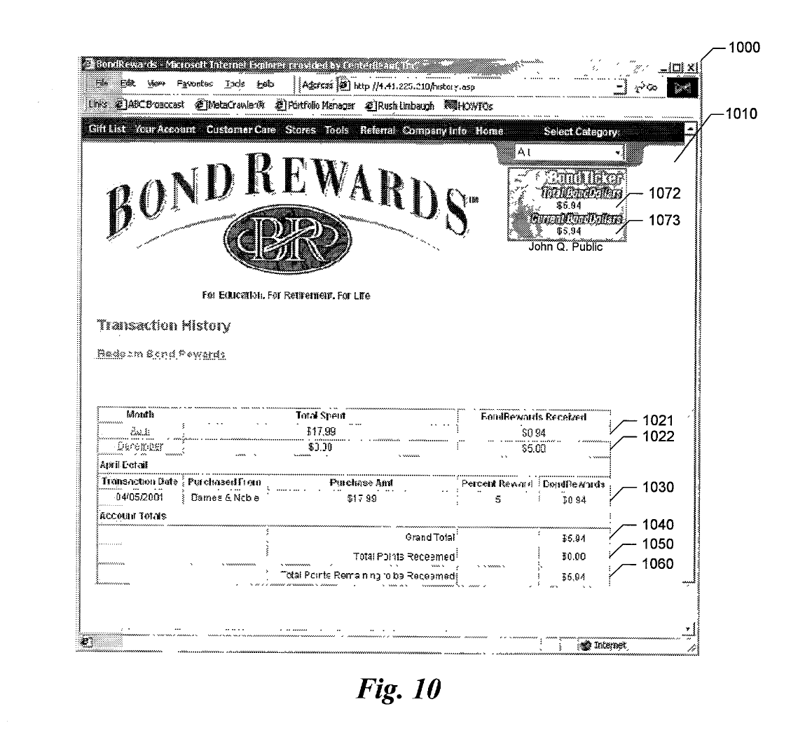

When the user selects link 920, the facility displays a page showing the user's transaction history. FIG. 10 is a display diagram showing a page of the loyalty program web site containing transaction history information for the member. The page 1010 includes line 1021 showing the total amount spent and the total BondDollars received in the month of April, and line 1022 showing the total amount spent and the total BondDollars received in the month of December. In line 1030, it can be seen that a purchase in the amount of $17.99 was made on Apr. 5, 2001, from the merchant Barnes & Noble at a reward percentage of five percent, earning the member 0.94 BondDollars. It can further be seen on lines 1040, 1050, and 1060 that the member has earned a total of 6.94 BondDollars, all of which remains to be redeemed. This information is also shown in lines 1072 and 1073, which are typically included on several of the pages of the loyalty program web site.

Once this member has accumulated 50 BondDollars, the member may select link 940 shown in FIG. 9 in order to redeem BondDollars for a savings bond. At any time, the member may select link 930 shown in FIG. 9 in order to transfer BondDollars from his or her own BondDollar account to the BondDollar account of another member.

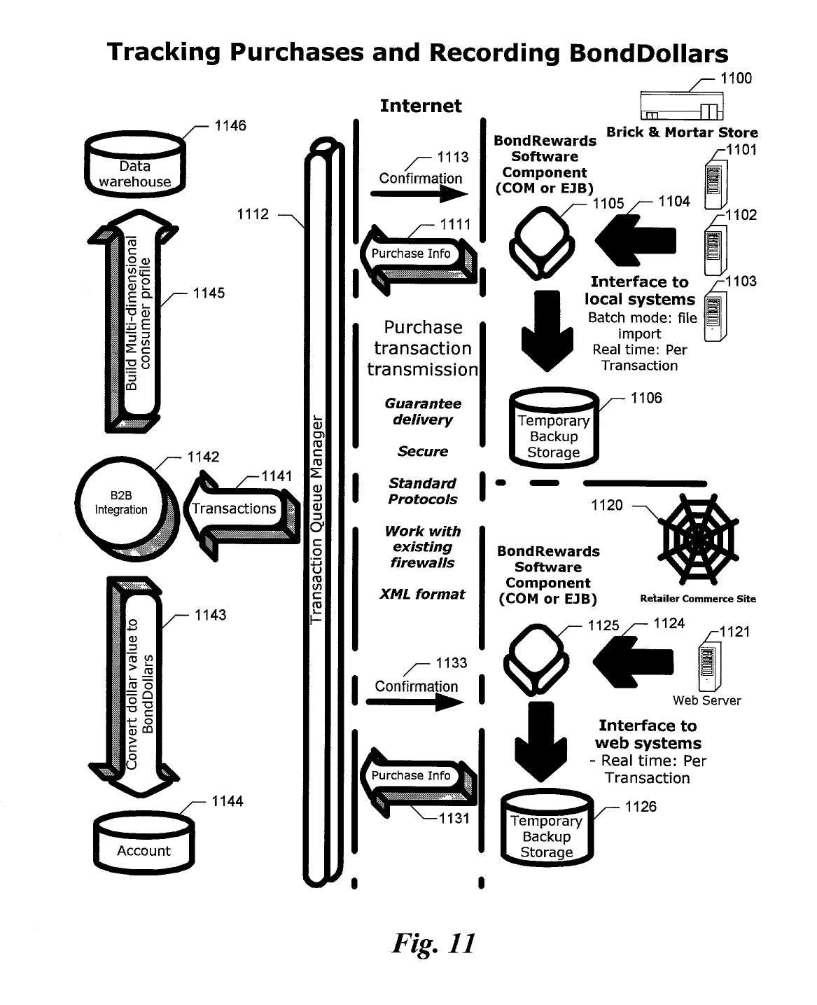

FIGS. 11-15 show details of the operation of the facility. FIG. 11 is a data flow diagram showing a typical flow of transaction information from merchants to the operator of the loyalty program in accordance with the facility. Elements 1100-1113 show data flow to and from a brick and mortar merchant 1100. Member transactions are collected from cash registers in each of the merchant's stores in a point of sale system server at that store, such as point of sale system servers 1101-1103. These transactions 1104 are passed to a software component 1105 provided by the operator of the loyalty program and executing under the control of the merchant; the operator of the loyalty program, or both. This component stores a backup copy of these transactions in a transaction archive 1106. The component further forwards these transactions, as purchase information 1111, to a transaction queue manager 1112 via the Internet. The transaction queue manager replies to the merchant with a confirmation 1113 confirming receipt of the purchase information. Elements 1120-1133 show data flow to and from a web merchant 1120. Member transactions 1124 are collected from the web server 1121 used to serve the web merchant's web site, and passed to a software component 1125 similar to software component 1105. This component stores a backup copy of these transactions in a transaction archive 1126. The component further forwards these transactions, as purchase information 1131, to a transaction queue manager 1112 via the Internet. The transaction queue manager replies to the merchant with a confirmation 1133 confirming receipt of the purchase information.

Transactions 1141 received by the transaction queue manager are forwarded to a business-to-business integration component 1142. The business-to-business integration component converts the amounts of these transactions from dollars to BondDollars, then sends the converted transactions 1143 to the member account database 1144 to be credited to the appropriate member's account. The business-to-business integration component also contributes information about the transaction 1145 to a multi-dimensional profile of the member maintained in a data warehouse 1146.

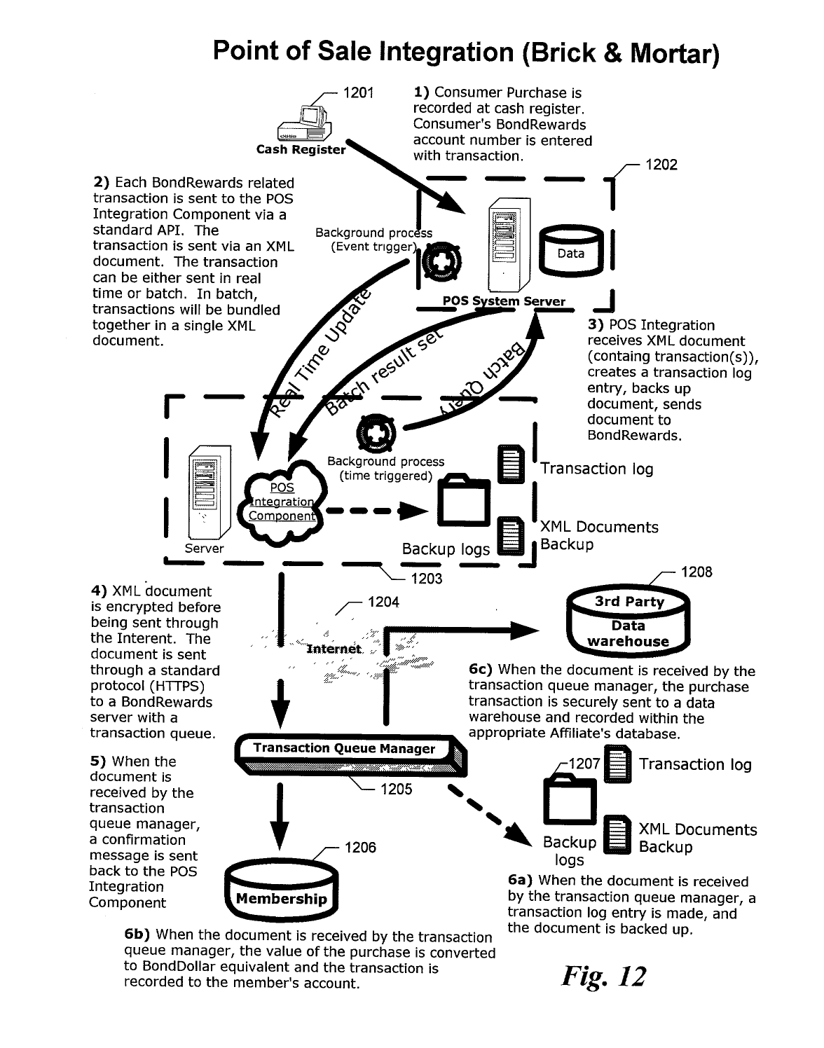

FIG. 12 is a data flow diagram showing additional detail regarding the processing of information about transactions conducted at a brick and mortar merchant, at the “point of sale.” When member purchases are made at a cash register 1201, an account number that identifies the member to the loyalty program is received at the cash register as part of the transaction. Information about this transaction is passed to a point of sale system server 1202, which maintains a record of all the transactions occurring at cash registers at this merchant location. Additionally, transactions may be received by the point of sale system server from various devices used by the merchant in place of, or to supplement, cash registers, including self-service kiosks cellular telephone-based checkout system, etc. The point of sale system server stores such transactions in its database.

These transactions, at least those performed by loyalty program members, are then transferred to a point of sale integration component 1203. The point of sale integration component may execute either on a different server under the control of the merchant, or directly on the point of sale system server. Such transfer of transactions may be performed either in real-time or batch mode. In real-time mode, an event trigger that can observe the receipt in the point of sale system server of each individual transaction, such as one that executes as a background process on the point of sale system server, sends information about each appropriate transaction to the point of sale integration component as the transaction is received in the point of sale system server. In batch mode, a background process executing on the server on which the point of sale integration component executes periodically issues a batch query to the point of sale system server requesting information about each of the appropriate transactions that have been received since the most recent batch query. In response, the point of sale system server sends the batch results to the point of sale integration component containing information about each of the outstanding appropriate transactions.

When transaction information is received by the point of sale integration component, it stores this information in one or more backup logs, such as a transaction log and an XML documents backup. The point of sale integration component further translates the received information about transactions into XML format if it is not already in that format, and encrypts it for transmission via the Internet 1204 to a transaction queue manager 1205 operated by the operator of the loyalty program.

When the transaction queue manager receives the encrypted information, it sends a confirmation message to the point of sale integration component, and decrypts the information. The information is recorded as a credit to the BondDollar account of the associated member in the membership database 1206; these transactions are stored in a transaction log in a backup log 1207; and the information in the transactions is used to augment a profile maintained for the merchant in the transaction of the member of the transaction stored in a third party data warehouse 1208 maintained on behalf of the merchant.

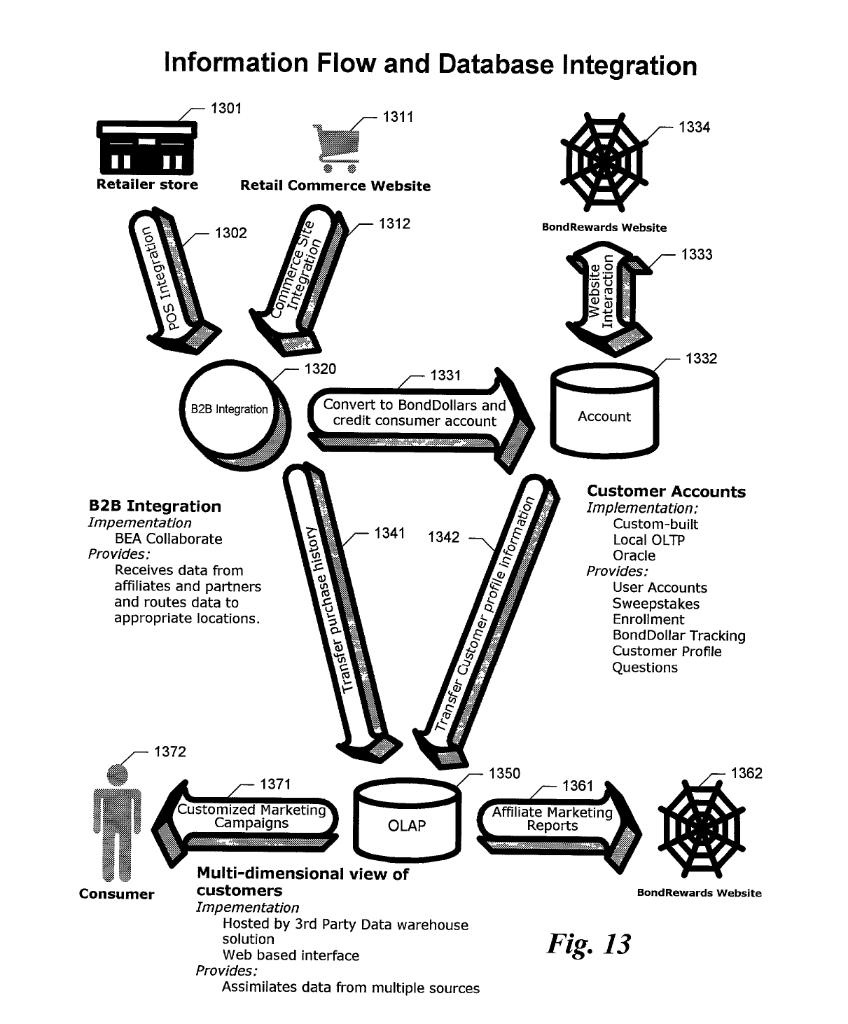

FIG. 13 is a data flow diagram showing additional detail regarding the processing of information within the control of the operator of the loyalty program. In this diagram, transactions are received by the business-to-business integration component 1320, both via the point of sale integration component 1302 from brick and mortar merchants 1301, and via a commerce site integration module 1312 from web merchants 1311. The business-to-business integration module converts the amount of each of the transactions to BondDollars reward currency and credits the appropriate member account in the account database 1332. The updated member account is accessible to the member via a web site interaction component 1333 at the loyalty program web site 1334. Also, purchase history 1341 from the business-to-business integration module and customer profile information 1342 from the account database are transferred to an online analytical processing database 1350. The information stored in the online analytical processing database supports both customized marketing campaigns 1371 directed to individual members 1372 and affiliate marketing reports 1361 provided to affiliated merchants via the BondRewards web site 1362.

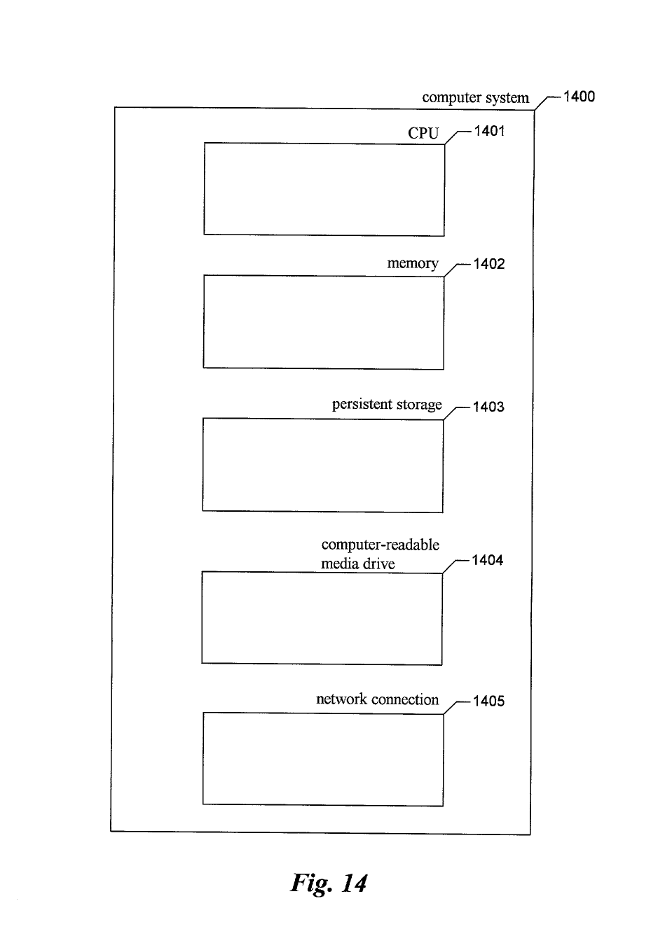

FIG. 14 is a block diagram showing some of the components typically incorporated in at least some of the computer systems and other devices on which the facility executes. These computer systems and devices 1400 may include one or more central processing units (“CPUs”) 1401 for executing computer programs; a computer memory 1402 for storing programs and data while they are being used; a persistent storage device 1403, such as a hard drive for persistently storing programs and data; a computer-readable media drive 1404, such as a CD-ROM drive, for reading programs and data stored on a computer-readable medium; and a network connection 1405 for connecting the computer system to other computer systems, such as via the Internet. While computer systems configured as described above are preferably used to support the operation of the facility, those skilled in the art will appreciate that the facility may be implemented using devices of various types and configurations, and having various components.

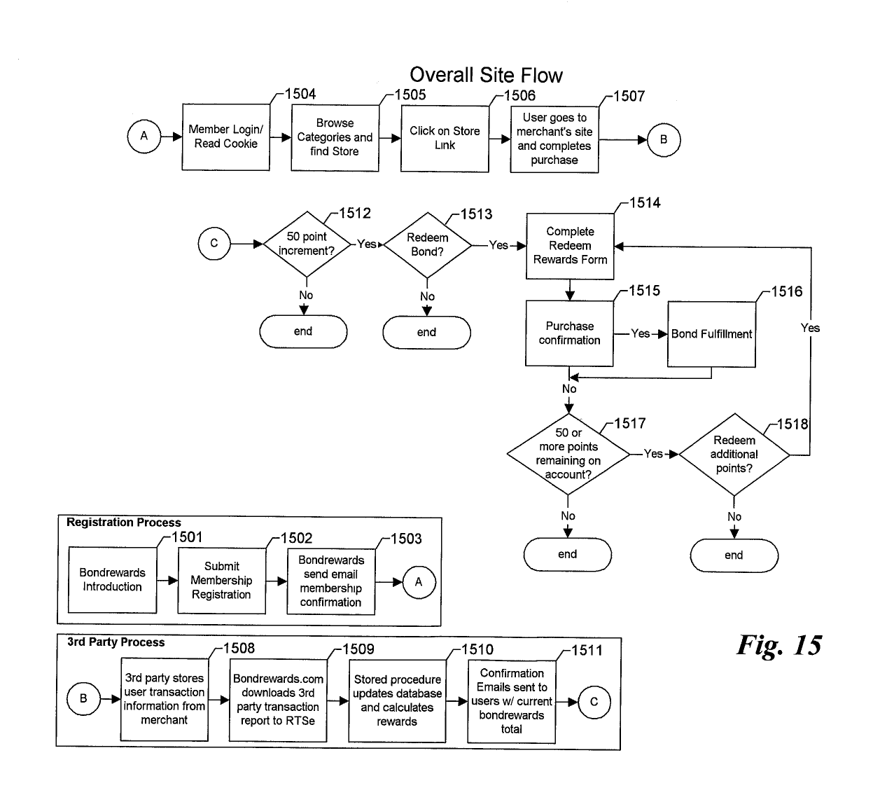

FIG. 15 is a flow diagram showing steps typically performed by the facility in order to conduct the loyalty program. Steps 1501-1503 constitute a registration process in which a new member registers for the loyalty program. In step 1501, the facility displays information about the loyalty program, such as by presenting a series of web pages describing different aspects of the loyalty program. In step 1502, the facility receives membership registration information from the new member. FIG. 1 shows an example of receiving such registration information. In step 1503, the facility sends an e-mail message to the new member confirming his or her membership. After step 1503, the facility continues in step 1504 via connector A.

Steps 1504-1507 are directed to identifying a member and directing that member to an affiliated merchant in order to make a purchase from the affiliated merchant. In step 1504, the facility identifies the member by reading a cookie containing information identifying the member from the member's computer system, or, if such a cookie is expired or otherwise not available, by soliciting login information from the user, such as a user ID and password. In step 1505, the facility displays information enabling the member to choose an affiliated merchant. For example, in some embodiments, the facility presents displays such as are shown in FIGS. 3-5. In step 1506, the facility receives an indication that the user has selected one of the displayed merchants. In step 1507, the facility forwards the member's browser to the web site of the selected merchant, along with information identifying the member to the merchant as a particular member of the loyalty program. After step 1507, the facility continues in step 1508 via connector B.

In some embodiments, some or all of the affiliated merchants are able to independently identify their customers as particular members of the loyalty program, such as by reading a cookie from the customer's computer system, or by having the customer log into the merchant web site. In such cases, steps 1504-1507 are omitted, and the member may reach the merchant web site in any manner. Indeed, in some cases, a member may make a purchase from such a merchant and earn BondDollars without being aware that the merchant is affiliated with the loyalty program.

Steps 1508-1511 are performed in the case of merchants who are affiliated with the loyalty program through a third-party referral network, rather than being directly affiliated to the loyalty program. For purchases from merchants that are directly affiliated with the loyalty program, rather than performing steps 1508-1511, the facility receives the transaction directly from the affiliated merchant, and continues in step 1512 via connector C. In step 1508, the third-party referral network stores user transaction information that it receives from the merchant. In step 1509, the facility downloads transaction information for transactions in which it acted as a referrer from the referral network. In step 1510, the facility, in a stored procedure, updates the member database with the transactions obtained from the referral network and calculates the associated BondDollar rewards. In step 1511, the facility sends confirmation e-mails to members with new transactions indicating their current bond rewards balances. After step 1511, the facility continues in step 1512 through connector C.

In step 1512, if the member's BondDollar balance is at least 50 BondDollars, then the facility continues in step 1513, else these steps conclude. In step 1513, the facility prompts the member to redeem BondDollars in exchange for a savings bond. If the member chooses to do so, then the facility continues in step 1514, else these steps conclude. In step 1514, the facility presents a form for completion by the user to designate such information as the recipient of the bond, the denomination of the bond, etc. In step 1515, the facility asks the member to confirm the purchase of the bond. If the member confirms the purchase of the bond, then the facility performs bond fulfillment in step 1516, else the facility proceeds directly to step 1517. Step 1516 typically involves transmitting information about the bond to be purchased, including information received from the user and the form completed in step 1514, to the appropriate division of the U.S. Department of the Treasury, or to the issuer of the bond or other reward instrument if it is other than the U.S. Department of the Treasury. In step 1517, if 50 or more BondDollars still remain in the member's account, then the facility continues in step 1518, else these steps conclude. In step 1518, the facility prompts the user to redeem additional BondDollars. If the member chooses to do so, then the facility continues in step 1514, else these steps conclude.

In some embodiments, when a member of the loyalty program visits the home page or other web page of an affiliated merchant, the facility augments the display of that web page to include the member's BondDollar balance, and or other information relating to the member's membership in the loyalty program. For example, in some embodiments, this involves the display of compact balance display 270 shown in FIG. 2, or a similar user interface construct. In these embodiments, the member receives a clear and immediate indication that a particular merchant is affiliated with the loyalty program, and that purchases from the merchant will be credited to the member's loyalty program balance. Further, the display of the amount of the loyalty program balance may encourage a member who would otherwise not make a purchase from the affiliated merchant to do so in order to exceed, or come closer to exceeding, the number of accumulated BondDollars needed to receive the next reward financial instrument.

It will be understood by those skilled in the art that the above-described facility could be adapted or extended in various ways. For example, the facility may be used to conduct loyalty programs in which the reward instrument is a financial instrument other than a Series EE U.S. Savings Bond, such as a U.S. Savings Bond of another type, other private and government savings bonds, certificates of deposit, or a wide variety of other financial instruments. A variety of different mechanisms may be used by the facility in order to track, process, and record transactions of affiliated merchants. Those affiliated merchants may sell any of a number of products and/or services; may provide reward currency in exchange for supplying information of a variety of types; may provide reward currency in exchange for entering into ongoing services contracts, or ongoing contracts of another nature. While the foregoing description makes reference to preferred embodiments, the scope of the invention is defined solely by the claims that follow and the elements recited therein.

1. A method in a computing system for rewarding purchases by a user from merchants among a set of merchants with a savings bond, the savings bond having a maturity value, comprising:
for each merchant of the set, determining a reward percentage signifying a fraction of the amount of purchases by the user from the merchant to be credited to a reward account established for the user;
receiving one or more electronic indications that the user has made a purchase from a merchant among the set of merchants, each electronic indication identifying the merchant from which the purchase was made and the amount of the purchase;
for each received indication, crediting to the reward account established for the user an amount determined by multiplying the amount of the purchase identified by the received indication by the reward percentage determined for the merchant identified by the received indication; and
when the balance of the reward account established for the user reaches the maturity value of the savings bond, placing an order to purchase the savings bond for the user.

2. The method of claim 1 wherein the savings bond is a Series EE United States savings bond.

3. The method of claim 1 wherein an order is placed by transmitting an electronic indication of the order to an issuer of the savings bond.

4. The method of claim 1, further comprising obtaining a mailing address for the user, wherein the placed order specifies that the ordered savings bond be mailed to the mailing address.

5. The method of claim 1 wherein the savings bond has an acquisition cost, the method comprising paying the acquisition cost of the savings bond in conjunction with the placed order.

6. The method of claim 1 wherein the savings bond has an acquisition cost, the method further comprising, for each received indication, charging the merchant identified by the received indication an amount between (1) A×B×C/D and (2) A×B, where A is amount of the purchase identified by the received indication, B is the reward percentage determined for the merchant identified by the received indication, C is the acquisition cost of the ordered savings bond, and D is the maturity value of the ordered savings bond.

7. The method of claim 1 wherein the method is performed for each of a plurality of users.

8. The method of claim 1, further comprising, after placing the order, reducing the balance of the reward account established for the user by the maturity value of the savings bond.

9. The method of claim 1, further comprising providing the balance of the reward account to the user.

10. The method of claim 1, further comprising providing the balance of the reward account to the user via the world wide web.

11. The method of claim 1, further comprising providing the balance of the reward account to the user via electronic mail.

12. The method of claim 1 wherein the placed order to purchase the savings bond for the user purchases the savings bond as a gift from the user to a donee designated by the user.

13. The method of claim 1 wherein the reward percentage determined for each merchant of the set is expressed in terms of the maturity value of the savings bond.

14. A method for marketing transactions using a reward currency, comprising:
(a) displaying information describing an offered transaction; and
(b) in conjunction with the information describing the offered transaction, displaying an indication of an amount of the reward currency that may be obtained by entering into the transaction, an accumulated amount of the reward currency equal to a known future value of a financial instrument being exchangeable for the financial instrument.

15. The method of claim 14, further comprising exchanging the known future value of a financial instrument for the financial instrument.

16. The method of claim 14 wherein the displayed information describing a transaction describes a purchase transaction.

17. The method of claim 14 wherein the displayed information describing a transaction describes an information provision transaction.

18. The method of claim 17 wherein the described information provision transaction is a survey of information relating to the person entering into the transaction.

19. The method of claim 18 wherein the described information provision transaction is a survey of demographic information relating to the person entering into the transaction.

20. The method of claim 19 wherein the described information provision transaction is a survey of marketing information relating to the person entering into the transaction.

21. The method of claim 14 wherein the displayed information describing a transaction resulting in an ongoing contract.

22. The method of claim 14 wherein the offered transaction may have an amount, and wherein the displayed indication of an amount of reward currency is a percentage of the amount of the offered transaction.

23. The method of claim 14 wherein the displayed indication of an amount of reward currency is an absolute amount of reward currency.

24. The method of claim 14 wherein the reward currency has a name containing the name of a national currency, the method further comprising displaying the name of the reward currency in conjunction with the displayed indication of an amount of reward currency.

25. The method of claim 14 wherein the reward currency has a name containing the word “dollar”, the method further comprising displaying the name of the reward currency in conjunction with the displayed indication of an amount of reward currency.

26. The method of claim 14 wherein the reward currency has a name containing the name of the financial instrument, the method further comprising displaying the name of the reward currency in conjunction with the displayed indication of an amount of reward currency.

27. The method of claim 14 wherein the reward currency has a name containing the word “bond”, the method further comprising displaying the name of the reward currency in conjunction with the displayed indication of an amount of reward currency.

28. The method of claim 14 wherein the reward currency has the name “BondDollar”, the method further comprising displaying the name of the reward currency in conjunction with the displayed indication of an amount of reward currency.

29. The method of claim 14 wherein the displaying is performed in a physical location of the party offering the transaction.

30. The method of claim 14 wherein the displaying is performed by erecting a non-transitory display.

31. The method of claim 30 wherein the non-transient display is a paper sign.

32. The method of claim 14 wherein the displaying is performed using a video display device.

33. The method of claim 14 wherein the displaying is performed by serving a web page containing the displayed information.

34. The method of claim 33 wherein the served web page is served as part of a website of the party offering the transaction.

35. The method of claim 33 wherein the served web page is served as part of a website of a reward currency program operator.

36. The method of claim 33 wherein transactions offered by multiple parties are marketed by the method, and wherein (a) and (b) are repeated for each of the parties whose transactions are marketed by the method.

37. The method of claim 33 wherein purchase transactions offered by multiple merchants are marketed by the method, and wherein (a) and (b) are repeated for each of the merchants whose purchase transactions are marketed by the method.

38. A computer-readable medium whose contents causes a computer system to market transactions using a reward currency by:
(a) displaying information describing an offered transaction; and
(b) in conjunction with the information describing the offered transaction, displaying an indication of an amount of the reward currency that may be obtained by entering into the transaction, an accumulated amount of the reward currency equal to a known future value of a financial instrument being exchangeable for the financial instrument.

39. A method in a computing system for operating a loyalty program, comprising:
monitoring purchases made by each of a plurality of customers from merchants among a limited set of merchants; and
conveying to customers among the plurality, selected based upon their monitored purchases, a financial instrument having a face value and an acquisition cost that is less than the face value.

40. The method of claim 39 wherein the acquisition cost of the conveyed financial instrument is substantially less than the face value of the financial instrument.

41. The method of claim 39 wherein the acquisition cost of the conveyed financial instrument is less than or equal to one-half of the face value of the financial instrument.

42. The method of claim 39 wherein the financial instrument is a bond.

43. The method of claim 39 wherein the financial instrument is a savings bond.

44. The method of claim 39 wherein the financial instrument is a US savings bond.

45. The method of claim 39 wherein the financial instrument is a Series EE US savings bond.

46. The method of claim 39 wherein the financial instrument is a certificate of deposit.

47. The method of claim 39 wherein the financial instrument is whose appreciation in value is exempted from income tax in at least one jurisdiction.

48. The method of claim 39, further comprising:
maintaining, for each of the plurality of customers, a reward currency balance;
for each monitored purchase, augmenting the reward currency balance maintained for the customer who made the purchase; and
each time the reward currency balance maintained for a customer exceeds a threshold amount, selecting the customer for conveyance of a financial instrument.

49. The method of claim 48 wherein the threshold amount is a face value of the financial instrument.

50. The method of claim 48 wherein a reward currency increment is associated with each monitored purchase, and wherein augmenting the reward currency balance maintained for the customer who made the purchase involves adding the reward currency increment associated with the monitored purchase to the reward currency balance maintained for the customer who made the purchase.

51. The method of claim 48, further comprising augmenting the reward currency balance maintained for a distinguished customer when the distinguished customer performs a distinguished action other than making a purchase.

52. The method of claim 51 wherein the distinguished action is completing a customer survey.

53. The method of claim 51 wherein the distinguished action is entering into a service contract.

54. The method of claim 53 wherein the reward currency balance maintained for the distinguished customer is augmented once for entering into a service contract.

55. The method of claim 53 wherein the reward currency balance maintained for the distinguished customer is augmented periodically for entering into a service contract, so long as the service contract remains in force.

56. The method of claim 51 wherein the distinguished action is referring a prospective member of the plurality of users who subsequently joins the plurality of users.

57. The method of claim 51 wherein the distinguished action is referring a prospective member of the plurality of users.

58. The method of claim 57 wherein the reward currency balance maintained for the distinguished customer is augmented to reflect changes to the reward currency balance maintained for the referred user.

59. The method of claim 48, further comprising:
receiving an instruction from a first user to transfer a specified portion of the reward currency balance maintained for the first customer to a second customer;
in response to receiving the instruction:
removing the specified portion from the reward currency balance maintained for the first customer; and
adding the specified portion to the reward currency balance maintained for the second customer.

60. A computing system for operating a loyalty program, comprising:
a purchase monitor subsystem that monitors purchases made by each of a plurality of customers from merchants among a limited set of merchants; and
a reward conveyance subsystem that conveys to customers among the plurality, selected based upon their monitored purchases, a financial instrument having a face value and an acquisition cost that is less than the face value.

61. A method in a computing system for operating a purchase reward program, comprising:
monitoring purchases made by each of a plurality of customers from merchants among a limited set of merchants; and
for customers among the plurality selected based upon their monitored purchases, arranging for the physical delivery of a financial instrument to the selected customers as a reward for their monitored purchases.

62. The method of claim 61 wherein arranging for the physical delivery of a financial instrument to a selected customer includes physically conveying the financial instrument to a delivery service for delivery to the selected customer.

63. The method of claim 61 wherein arranging for the physical delivery of a financial instrument to a selected customer includes physically conveying the financial instrument to an address associated with the selected customer.

64. The method of claim 61 wherein arranging for the physical delivery of a financial instrument to a selected customer includes instructing a third party to physically convey the financial instrument to a delivery service for delivery to the selected customer.

65. The method of claim 61, further comprising:
maintaining, for each of the plurality of customers, a reward currency balance;
for each monitored purchase, augmenting the reward currency balance maintained for the customer who made the purchase; and
each time the reward currency balance maintained for a customer exceeds a threshold amount, selecting the customer for conveyance of a financial instrument.

66. The method of claim 65 wherein the threshold amount is a guaranteed future value of the financial instrument.

67. The method of claim 65 wherein a reward currency increment is associated with each monitored purchase, and wherein augmenting the reward currency balance maintained for the customer who made the purchase involves adding the reward currency increment associated with the monitored purchase to the reward currency balance maintained for the customer who made the purchase.

68. The method of claim 65, further comprising augmenting the reward currency balance maintained for a distinguished customer when the distinguished customer performs a distinguished action other than making a purchase.

69. A computer-readable medium whose contents cause a computing system to operate a purchase reward program by:
monitoring purchases made by each of a plurality of customers from merchants among a limited set of merchants; and
for customers among the plurality selected based upon their monitored purchases, arranging for the physical delivery of a financial instrument to the selected customers as a reward for their monitored purchases.

70. A method in a computing system for operating a loyalty program, comprising:
monitoring purchases made by each of a plurality of customers from merchants among a limited set of merchants; and
conveying to customers among the plurality, selected based upon their monitored purchases, a negotiable financial instrument.

71. The method of claim 70 wherein the financial instrument is of a type that enables it to be given as a gift to a third party.

72. The method of claim 70 wherein the financial instrument is of a type that enables it to be sold to a third party.

73. The method of claim 70 wherein the financial instrument is of a type that enables it to be redeemed in exchange for cash.

74. The method of claim 73 wherein the amount of cash for which the financial instrument may be redeemed is guaranteed to increase over time.

75. A computing system for operating a loyalty program, comprising:
a purchase monitor subsystem that monitors purchases made by each of a plurality of customers from merchants among a limited set of merchants; and
a reward conveyance subsystem that conveys to customers among the plurality, selected based upon their monitored purchases, a negotiable financial instrument.

76. A method in a computing system for operating a loyalty program, comprising:
monitoring purchases made by each of a plurality of customers from merchants among a limited set of merchants; and
enlisting a third party to provide to customers among the plurality, selected based upon their monitored purchases, a reward for making the monitored purchases.

77. The method of claim 76 wherein the enlisted third party is a government agency.

78. The method of claim 76 wherein the enlisted third party is a government treasury.

79. The method of claim 76 wherein the enlisted third party is The United States Department of the Treasury.

80. The method of claim 76 wherein the enlisted third party is The United States Bureau of the Public Debt.

81. The method of claim 76 wherein the enlisted third party is The United States Federal Reserve System.

82. A computer-readable medium whose contents causes a computer system to operate a loyalty program by:
monitoring purchases made by each of a plurality of customers from merchants among a limited set of merchants; and
enlisting a third party to provide to customers among the plurality, selected based upon their monitored purchases, a reward for making the monitored purchases

83. One or more computer memories collectively containing a merchant reward percentage data structure, the contents of the data structure indicating, for each of a plurality of merchants, the percentage of the amount of a purchase from the merchant that the merchant agrees to credit to a reward account of the purchaser, credits to purchaser reward accounts totaling a known future value of a financial instrument being exchangeable for the financial instrument.

84. One or more computer memories collectively containing a reward program member balance data structure indicating, for each of a plurality of reward program members, a reward currency balance, each reward currency balance being expressed in units such that a reward currency balance equal to the face value of a selected type of savings bond may be exchanged for a savings bond of the selected type.

85. A method in a client computer system for displaying a web page of a merchant that is affiliated with a loyalty program, comprising:
receiving information from one or more external sources; and
using the received information to display a web page of the merchant in such a way that information about the loyalty program is incorporated in the display of the web page.

86. The method of claim 85 wherein the incorporated information about the loyalty program includes an indication that the merchant is affiliated with the loyalty program.

87. The method of claim 85 wherein a user of the client computer system is a member of the loyalty program, and wherein this member of the loyalty program has a loyalty program reward balance, and wherein the incorporated information about the loyalty program includes an indication of the loyalty program reward balance for the member.

88. The method of claim 87 wherein the indication of the loyalty program reward balance for the member is displayed in terms of a future value of a reward financial instrument for which the loyalty program reward balance may be exchanged when the loyalty program reward balance grows large enough.

89. The method of claim 85 wherein the information is received from an external source associated with the merchant, who incorporates the information about the loyalty program with the web page.

90. The method of claim 85 wherein the information is received from an external source associated with an operator of the loyalty program, who incorporates the information about the loyalty program with the web page.

91. The method of claim 85 wherein the information is received from external source associated with both the merchant and an operator of the loyalty program.

92. The method of claim 85 wherein the receiving comprises:
receiving information comprising the web page from the merchant, the information comprising the web page including a link to the information about the loyalty program; and
dereferencing the received link to retrieve the information about the loyalty program from an operator of the loyalty program.

93. The method of claim 92 wherein a user of the client computer system is a member of the loyalty program, and wherein this member of the loyalty program has a loyalty program reward balance, and wherein the dereferencing comprises using a member identifier stored for the member on the client computer system to request the loyalty program reward balance for the member from an operator of the loyalty program.
